(19) United States
(12) Patent Application Publication
(10) Pub. No.: US 2010/0008670 A1
(43) Pub. Date: Jan. 14, 2010

(54) WAVELENGTH SELECTIVE SWITCH USING PLANAR LIGHTWAVE CIRCUIT TECHNOLOGY

(75) Inventors: Jang-Uk Shin, Daejeon (KR); Young-Tak Han, Daejeon (KR); Sang-Pil Han, Daejeon (KR); Sang-Ho Park, Daejeon (KR); Yongsoon Baek, Daejeong (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/275,553

(22) Filed: Nov. 21, 2008

(30) Foreign Application Priority Data
Jul. 9, 2008 (KR) 10-2008-0066470

(51) Int. Cl. H04J 14/08

(52) U.S. Cl. 398/79

(57) ABSTRACT

Provided is a wavelength selective switch. The wavelength selective switch includes a first wavelength division multiplexer, an M number of optical switches, an (M+N−1) number of optical combiners, and a second wavelength division multiplexer. The first wavelength division multiplexer receives optical signals of an M number of wavelength channels to divide the received optical signals according to each channel, thereby outputting the divided optical signals. The M number of optical switches changes a path of on an optical signal outputted by an M number of wavelength channels from the first wavelength division multiplexer into one of an N number of output ports. The (M+N−1) number of optical combiners is respectively connected to the N number of output ports of the optical switches. The (M+N−1) number of optical combiners couple the N number of inputted optical signals to one output port. The second wavelength division multiplexer has an (M+N−1) number of input ports and an N number of output ports. The (M+N−1) number of output signals of the optical combiners is connected to the input ports, respectively, and the inputted signals are multiplexed to output the multiplexed signals from any of the N number of output ports.

### CROSS-REFERENCE TO RELATED APPLICATIONS

This U.S. non-provisional patent application claims priority under 35 U.S.C. §119 of Korean Patent Application No. 10-2008-0066470, filed on Jul. 9, 2008, the entire contents of which are hereby incorporated by reference.

### BACKGROUND OF THE INVENTION

The present invention disclosed herein relates to a wavelength selective switch used in a wavelength division multiplexing optical transmission system for simultaneously transmitting optical signals of different optical wavelengths, and more particularly, to a wavelength selective switch that can be simply realized through a planar lightwave circuit technology.

A wavelength selective switch is a switch that can selectively connect an arbitrary optical channel (corresponding to an arbitrary wavelength) with an arbitrary input/output port in a wavelength division multiplexing optical transmission system, where a plurality of optical channels with different wavelengths are transmitted through one optical line. The present invention relates to a 1×N wavelength selective switch including an input port and an output port, which are connected to an optical line for transmitting the M number of wavelengths (M is an integer greater than 1 and N is an integer equal to or less then M). Additionally, the 1×N wavelength selective switch selectively outputs all kinds of wavelengths in the optical line into the arbitrary N number of output ports. Furthermore, provided is a method of fabricating a highly reliable wavelength selective switch through a planar lightwave circuit technology.

FIG. 1 is a view of a wavelength selective switch 10 using a typical planar lightwave circuit technology. Referring to FIG. 1, the wavelength selective switch 10 includes an input port 11, a wavelength division multiplexer 12, variable optical attenuators 13, 1×N optical switches 14, the N number of wavelength division multiplexers 15, and output ports 16.

Optical signals of a plurality of channels corresponding to different wavelengths are inputted into the input port 11. The inputted optical signals are divided according to each of the wavelengths to output the divided optical signals. The optical signals divided according to each of the wavelengths are transmitted to the variable optical attenuators 13 along each of optical waveguides.

The variable optical attenuators 13 balance optical powers between the channels by adjusting adequately the optical signals according to each of the channels. The optical signals in which the optical powers are adequately adjusted in the variable optical attenuators 13 are outputted from one of the N number of output ports through the 1×N optical switches 14. Each of the output ports of the 1×N optical switches 14 are connected to one of the N number of wavelength division multiplexers 15. Here, the integer N is equal to the number of output ports of the wavelength selective switch 10. Thus, the optical signals outputted from the optical switches 14 are transmitted to one of the N number of wavelength division multiplexers 15 and outputted from an arbitrary output port. Therefore, when an optical path is adjusted in each of the 1×N optical switches 14 connected to a channel of an arbitrary wavelength, an optical signal of the channel is outputted from an arbitrary output port. The wavelength selective switch 10 can operate in a reverse direction with respect to the optical transmission direction.

In the typical planar waveguide 1×N wavelength selective switch 10, the (1+N) number of the wavelength division multiplexers 12, 15 and the 1×N optical switches 14 having the same number as the channels are essentially used as optical components. In case of the wavelength division multiplexers 12, 15, it is difficult to apply a planar lightwave circuit technology. Furthermore, a large area is required for realizing the wavelength division multiplexers 12, 15. Also, the complex fabrication process technology is required due to difficult wavelength tuning and a high defect rate. Thus, in case of the typical planar waveguide 1×N wavelength selective switch 10 requiring for a large number of wavelength division multiplexers 12, 15, its defect rate is increased and also its productivity is decreased due to complex fabrication processes. The wavelength selective switch described above is disclosed in Japanese Published Patent Application No. 2007-148042, titled “Wavelength Selective Optical Switch, Optical Combiner, And Wavelength Selective Optical Switch Module”, which is hereby incorporated by reference.

### SUMMARY OF THE INVENTION

The present invention provides a wavelength selective switch having a simple structure which minimizes the number of wavelength division multiplexers in which technical implementation is difficult and fabricating costs expensive and a method for fabricating the same.

Embodiments of the present invention provide wavelength selective switches including: a first wavelength division multiplexer receiving optical signals of an M (integer greater than 1) number of wavelength channels to divide the received optical signals according to each channel, thereby outputting the divided optical signals; an M number of optical switches changing a path of an optical signal outputted by an M number of wavelength channels from the first wavelength division multiplexer into one of an N (an integer greater than 1 and equal to and less than the integer M) number of output ports; an (M+N−1) number of optical combiners respectively connected to the N number of the optical switches, and a second wavelength division multiplexer having an (M+N−1) number of input ports and an M number of output ports, wherein the (M+N−1) number of output signals of the optical combiners are connected to the input ports, respectively, and the inputted signals are multiplexed to output the multiplexed signals from the N number of output ports.

In the above embodiments, a J-th (reference symbol J is an integer greater than 1 and less than the integer M) output port of an I-th (reference symbol I is an integer greater than 1 and less than the integer N) optical switch of the optical switches may be connected to one of the input ports of an (I+J-1)th optical combiner.

In other embodiments, the wavelength selective switch may further include variable optical attenuators or optical amplifiers, which adjust the optical signals according to the channels between the first wavelength division multiplexer and the optical switches.

In still other embodiments, the first and second wavelength division multiplexers may be implemented as an array-waveguide wavelength division multiplexer.

In even other embodiments, the first and second wavelength division multiplexers may be implemented as a reflection type diffraction grating wavelength division multiplexer.

In yet other embodiments, each of the optical switches may add one input port and one output port, thereby providing more outputs than the N number by connecting a plurality of wavelength selective switches to each other using the added input port and output port.

In further embodiments, the wavelength selective switch may be implemented as a single integrated optical device on one planar substrate.

In still further embodiments, optical devices used in the wavelength selective switch may be connected using optical fibers, respectively.

In other embodiments of the present invention, wavelength selective switches include: a first wavelength division multiplexer receiving optical signals of an M (integer greater than 1) number of wavelength channels to divide the received optical signals according to each channel, thereby outputting the divided optical signals; an M number of optical switches changing a path of on an optical signal outputted by an M number of wavelength channels from the first wavelength division multiplexer into one of an N (an integer greater than 1 and equal to and less than the integer M) number of output ports; and a second wavelength division multiplexer connected to the optical switches and having an (N×(M-1)+(N−1)×(N−1)+1) number of input channels and an N number of output channels, wherein a wavelength spacing between the input channels is 1/N of a channel wavelength of the optical signal, and a wavelength spacing between the output channels is 1/(N−1) of the channel wavelength of the optical signal.

In the above embodiments, a J-th (reference symbol J is an integer greater than 1 and less than the integer M) output port of an I-th (reference symbol I is an integer greater than 1 and less than the integer N) optical switch of the optical switches may be connected to an (N×(I-1)+(N−1)×(J-1)+1)th input port of the second wavelength division multiplexer.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a view of a wavelength selective switch using a typical planar lightwave circuit technology;

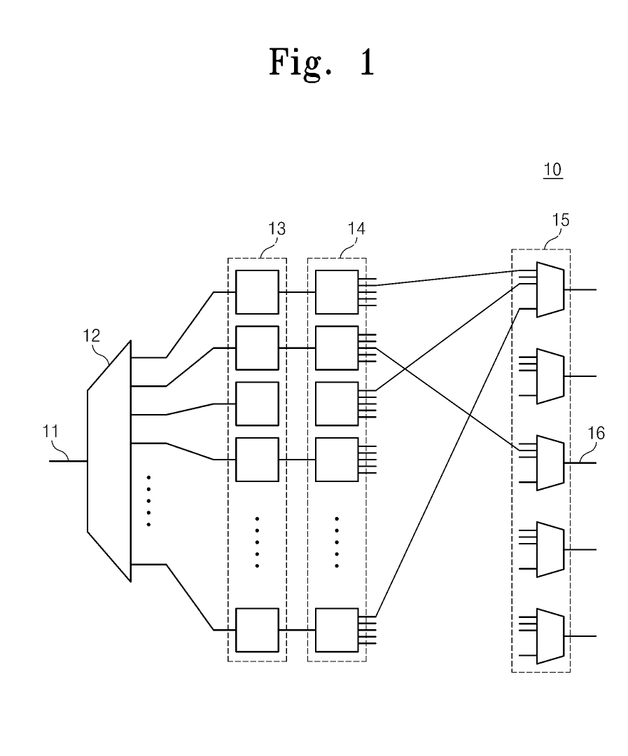

FIG. 2 is a view of a wavelength selective switch according to an embodiment of the present invention;

FIG. 3 is a view of a second wavelength division multiplexer according to an embodiment of the present invention;

FIG. 4 is a view of a 1×N optical switch according to an embodiment of the present invention;

FIG. 5 is a view of an N-channel optical combiner according to an embodiment of the present invention;

FIG. 6 is a view of a wavelength selective switch in which optical combiners are removed according to the present invention and a method of removing a division loss of the optical combiners;

FIG. 7 is a view illustrating a method for increasing a number of input/output ports by coupling a plurality of wavelength selective switches according to the present invention; and

FIG. 8 is a view illustrating a method for changing a 1×N optical switch into a 2×(N+1) optical switch separately adding one input port and one output port thereto so that a plurality of wavelength selective switches is connected to each other.

### DETAILED DESCRIPTION OF PREFERRED EMBODIMENTS

Preferred embodiments of the present invention will be described below in more detail with reference to the accompanying drawings so that this disclosure will be thorough and complete, and will fully convey the scope of the present invention to those skilled in the art.

A wavelength selective switch using a planar lightwave circuit technology according to the present invention includes only two wavelength division multiplexers. Thus, the wavelength selective switch can increase reliability of a switching operation and reduce an occupation area as well as manufacturing costs.

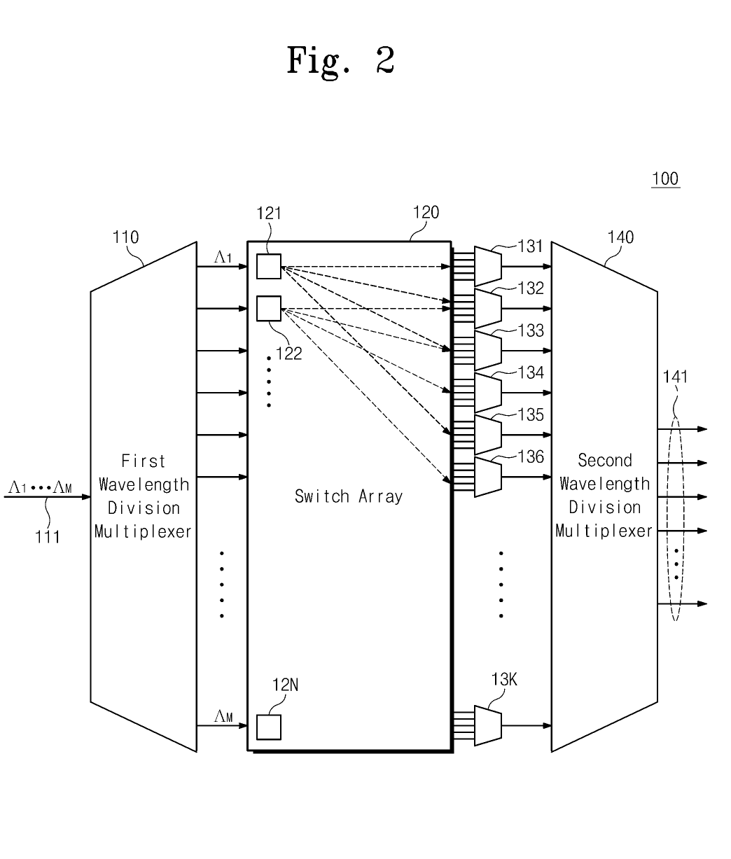

FIG. 2 is a view of a wavelength selective switch 100 according to an embodiment of the present invention. Referring to FIG. 2, the wavelength selective switch 100 includes a first wavelength division multiplexer 110, a switch array 120, optical combiners 131, 132, . . . , and 13K, and a second wavelength division multiplexer 140. An optical signal progresses as described below.

Optical signals of the M number of wavelength channels are inputted into an input port 111 of the first wavelength division multiplexer 110 through a wavelength division multiplex optical transmission line. The optical signals received from the wavelength division multiplex optical transmission line are split into multiple channels according to their wavelengths and outputted from the M number of output ports of the first wavelength division multiplexer 110. Thus, the first wavelength division multiplexer 110 includes at least one input port and at least the M number or more of channels of the wavelength division multiplex optical transmission line.

The optical signals outputted from each of the channels of the first wavelength division multiplexer 110 are inputted into 1×N optical switches. Each of variable optical attenuators (not shown) may be disposed between each of the output ports of the first wavelength division multiplexer 110 and each of the 1×N optical switches connected thereto.

A total number of the 1×N optical switches is equal to that of the wavelength channels of the optical line. Also, all of the 1×N optical switches are packaged in an array form to constitute the switch array 120. That is, the switch array 120 includes the M number of the 1×N optical switches 121 through 12M. Here, the reference symbol N is an integer equal to or less than the integer M.

Each of the N number of output signals of the 1×N optical switches is inputted into one of the optical combiners 131, 132, . . . , and 13K capable of receiving N channels (hereinafter, referred to as “N-channel optical combiners”). A total number of the N-channel optical combiners 131, 132, . . . , and 13K connected to output ports of the 1×N optical switches is (M+N−1). The optical signals received from the N-channel optical combiners 131, 132, . . . , and 13K are inputted into the second wavelength division multiplexer 140 which has the (M+N−1) number of input ports and the N number of output ports 141.

A method for connecting the 1×N optical switches to the N-channel optical combiners 131, 132, . . . , and 13K will now be described in detail. A first output port of a 1×N optical switch 121 of a first channel (hereinafter, referred to as a “first channel 1×N optical switch 121”) is connected to one of input ports of a first N-channel optical combiner 131. A second output port of the first channel 1×N optical switch 121 is connected to one of input ports of a second N-channel optical combiner 132. A third output port of the first channel 1×N optical switch 121 is connected to one of the input ports of the third N-channel optical combiner 133. As described above, the N number of output ports of the first channel 1×N optical switch 121 is connected to one of the input ports of the N-channel optical combiners from the first to the N-th optical combiner, respectively.

In case of a second channel 1×N optical switch 122, their connection method has the same method as the first channel 1×N optical switch 121. The N number of output signals of the second channel 1×N optical switch 122 is inputted into one of input ports of an N channel optical combiners from the second to the (N+1)th optical combiner. As described above, a J-th output port of an I-th 1×N optical switch 121 is connected to one of input ports of an (I+J-1)th optical combiner 13(I+J-1).

An operation principle of the wavelength selective switch 100 according to the present invention will now be described. The optical output signal of the first channel wavelength of the first wavelength division multiplexer 110 is transmitted to one of the input ports from the first to the N-th input port of the second wavelength division multiplexer 140 through the first 1×N optical switch 121 and one of the optical combiners from the first to the N-th optical combiner. In case where the output signal is inputted into a first input port, the received signal is outputted from a first output port of the second wavelength division multiplexer 140. In the case where the output signal is inputted into a second input port of the second wavelength division multiplexer 140 through a second optical combiner 132 by changing an optical path in the first 1×N optical switch 121, the received signal is outputted from a second output port of the second wavelength division multiplexer 140.

Accordingly, the optical signal of the first channel wavelength can be outputted from a predetermined output port from the first to the N-th output port of the second wavelength division multiplexer 140 according to a connection position of the first 1×N optical switch 121. By the same method, an optical signal of an I-th channel wavelength of the first wavelength division multiplexer 110 can be inputted into one of input ports from the I-th to the (I+N−1)th input port of the second wavelength division multiplexer 140 according to a connection position of an I-th 1×N optical switch 121 to output the received signal into a predetermined output port of output ports from the first to the N-th output port. Optical signals of all wavelength channels can be outputted from the predetermined output port of the output ports from the first to the N-th output port of the second wavelength division multiplexer 140 according to connection positions of the 1×N optical switches connected to each of the channel wavelengths. The operation principle of the wavelength selective switch 100 according to the present invention may be applied in the same manner in the case where a propagation direction of the optical signal is a direction opposite to the direction described above.

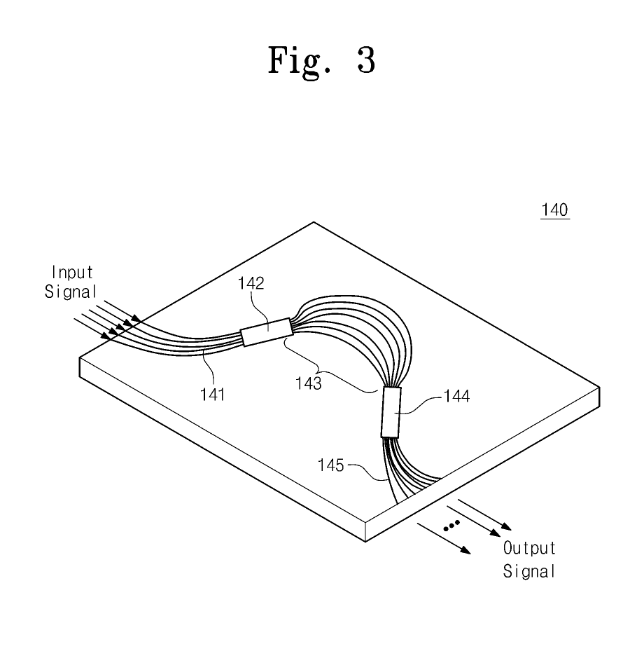

FIG. 3 is a view of a second wavelength division multiplexer 140 according to an embodiment of the present invention. Referring to FIG. 3, the second wavelength division multiplexer 140 includes the (M+N−1) number of input waveguides 141, a first slab waveguide 142, array waveguides 143, a second slab waveguide 144, and the N number of output waveguides 145.

In case of the array-waveguide wavelength division multiplexer 140 according to the present invention, when each of channel wavelengths is inputted into a port corresponding to each of input channels, all wavelengths are multiplexed and outputted from an assigned output port. When each of the channel wavelengths is inputted into an input channel moved from an assigned input port to an I-th input port, the received wavelength is also outputted from the I-th output port moved from the assigned output port. The array-waveguide wavelength division multiplexer 140 uses such a property.

It will be obvious, however, to one skilled in the art that the present invention is not limited to the array-waveguide wavelength division multiplexer illustrated in FIG. 3. Various types of wavelength division multiplexers may be used as wavelength division multiplexers such as a reflection type diffraction grating wavelength division multiplexer and other wavelength division multiplexers having the property in which the output port is moved when the wavelength is changed.

Also, the first wavelength division multiplexer 110 may have the same structure as the second wavelength division multiplexer 140 illustrated in FIG. 3. In this case, one input waveguide and the M number of output waveguides are provided.

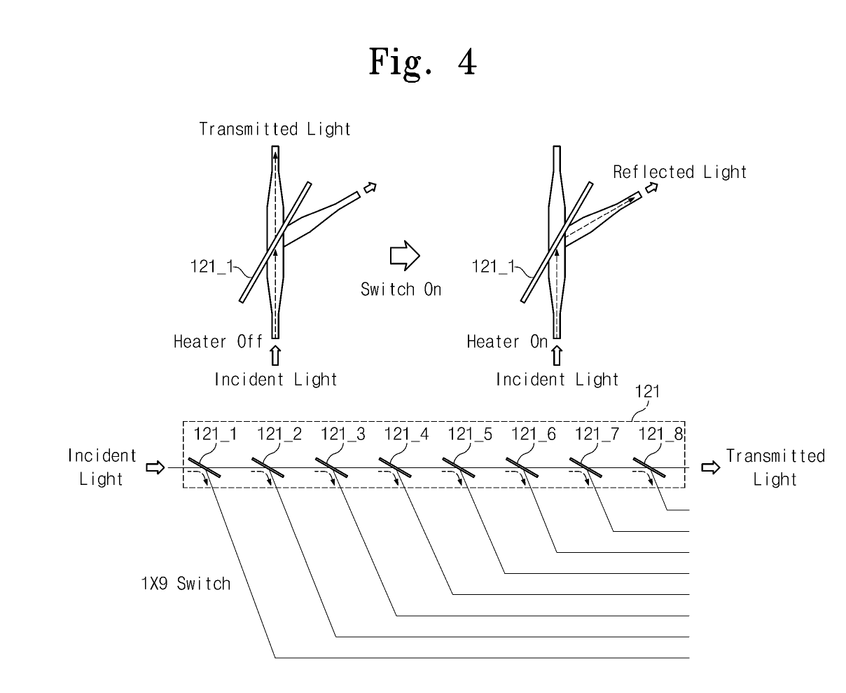

FIG. 4 is a view of a 1×N optical switch 121 according to an embodiment of the present invention. The 1×N optical switch 121 is a 1×9 optical switch using eight polymer total internal reflection (TIR) optical switches 121_1 through 121_8. Each of the polymer TIR optical switches 121_1 through 121_8 performs a switching operation according to an on-off operation of a heater. Referring to FIG. 4, when the heater turns off, the polymer TIR optical switch 121_1 transmits incident light. On the other hand, when the heater turns on, the polymer TIR optical switch 121_1 reflects incident light.

An optical signal inputted into the 1×9 optical switch 121 is transmitted to a predetermined output port of nine optical output ports when one of the eight polymer TIR optical switches 121_1 through 121_8 operates.

Although the 1×N optical switch 121 illustrated in FIG. 4 is implemented using the polymer TIR optical switches, it will be obvious to one skilled in the art that the present invention is not limited thereto. The 1×N optical switch 121 may be implemented using a Mach-Zehnder (MZ) interferometer type optical switch or optical switches capable of changing an optical path using various methods.

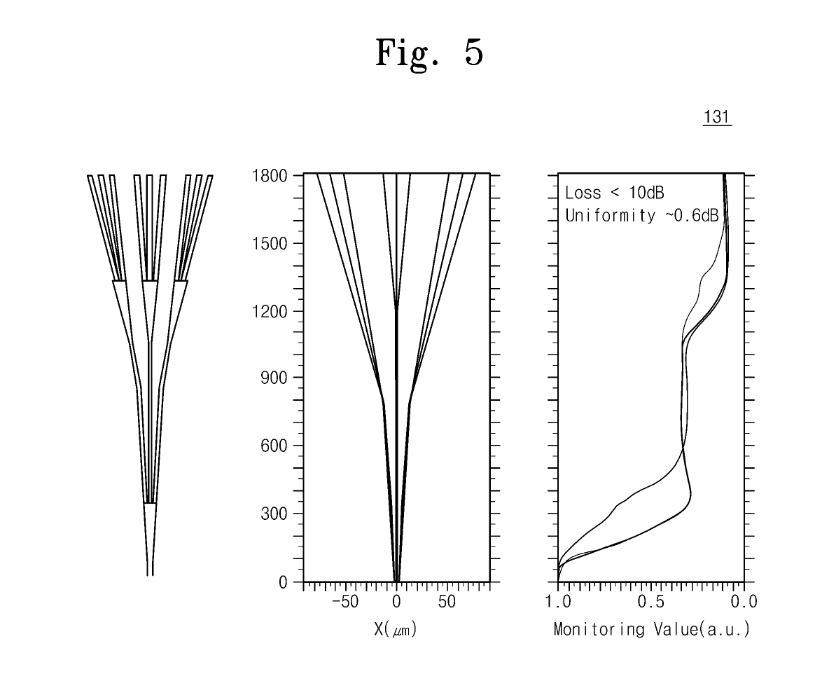

FIG. 5 is a view of an N-channel optical combiner 131 according to an embodiment of the present invention. The N-channel optical combiner 131 may be implemented using optical combiners having various structures such as a star coupler in addition to the N-channel optical combiner illustrated in FIG. 5.

The N-channel optical combiner 131 causes an optical loss because the optical signal power is reduced to 1/N. For example, in case of five channel optical combiners, a theoretical optical power loss of about 7 dB occurs. In the wavelength switch according to the present invention, the increase of the optical loss mainly occurs in the optical combiner. Thus, in order to solve the generation of the optical loss, the optical combiner loss must be essentially removed.

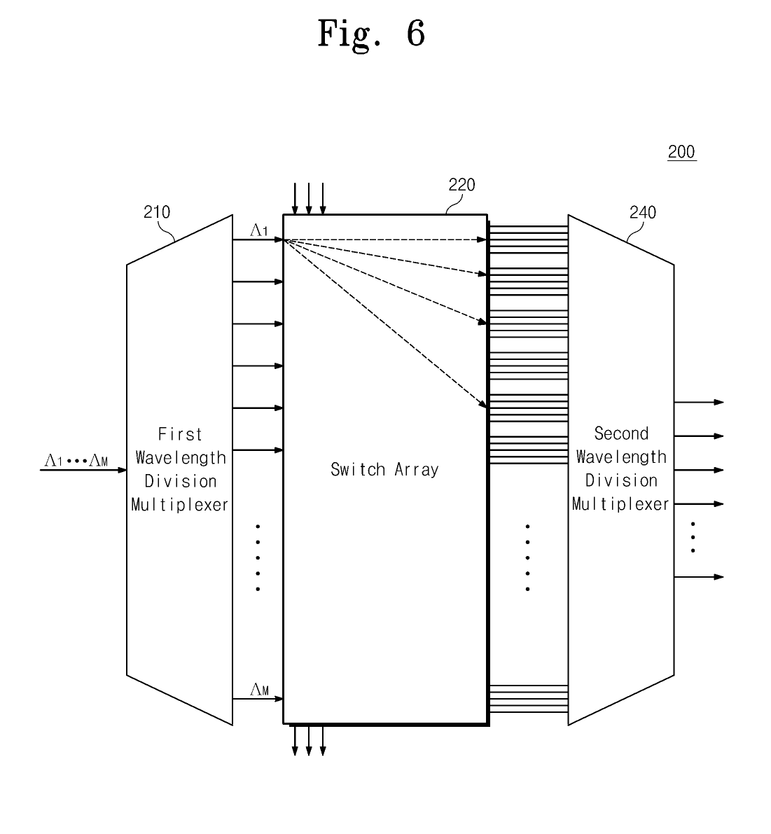

FIG. 6 is a view of a wavelength selective switch 200 in which optical combiners are removed according to the present invention and a method for removing a division loss of the wavelength selective switch 200. Referring to FIG. 6, the wavelength selective switch 200 includes a first wavelength division multiplexer 210, a 1×N switch array 220, and a second wavelength division multiplexer 240. The first wavelength division multiplexer 210 has the same structure as the first wavelength division multiplexer 110 illustrated in FIG. 2, and the 1×N switch array 220 has the same structure as the 1×N switch array 120 illustrated in FIG. 2.

The second wavelength division multiplexer 240 has the {N×(M-1)+(N−1)×(N−1)+1} number of input channels in order to remove dividers. A wavelength spacing between input channels of the second wavelength division multiplexer 240 is changed into 1/N of an original channel wavelength spacing, and a wavelength spacing between output channels of the second wavelength division multiplexer 240 is changed into 1/(N−1) of an original channel wavelength spacing. As described above, the input channels of the second wavelength division multiplexer 240 in which the number of the input channels and the wavelength spacing between the input channels are changed is directly connected to output ports of 1×N optical switches without using optical combiners. In a connection method of the output ports of the 1×N optical switches, a J-th output port of an I-th switch is connected to an {N×(I-1)+(N−1)×(J-1)+1}th input channel of the changed second wavelength division multiplexer 240.

The above embodiment integrates the combiner function having the division loss into a wavelength division multiplexing function of the second wavelength division multiplexer 240. When this method is used, the division loss of the optical combiner can be removed, but the number of the input ports of the second wavelength division multiplexer 240 should significantly increase.

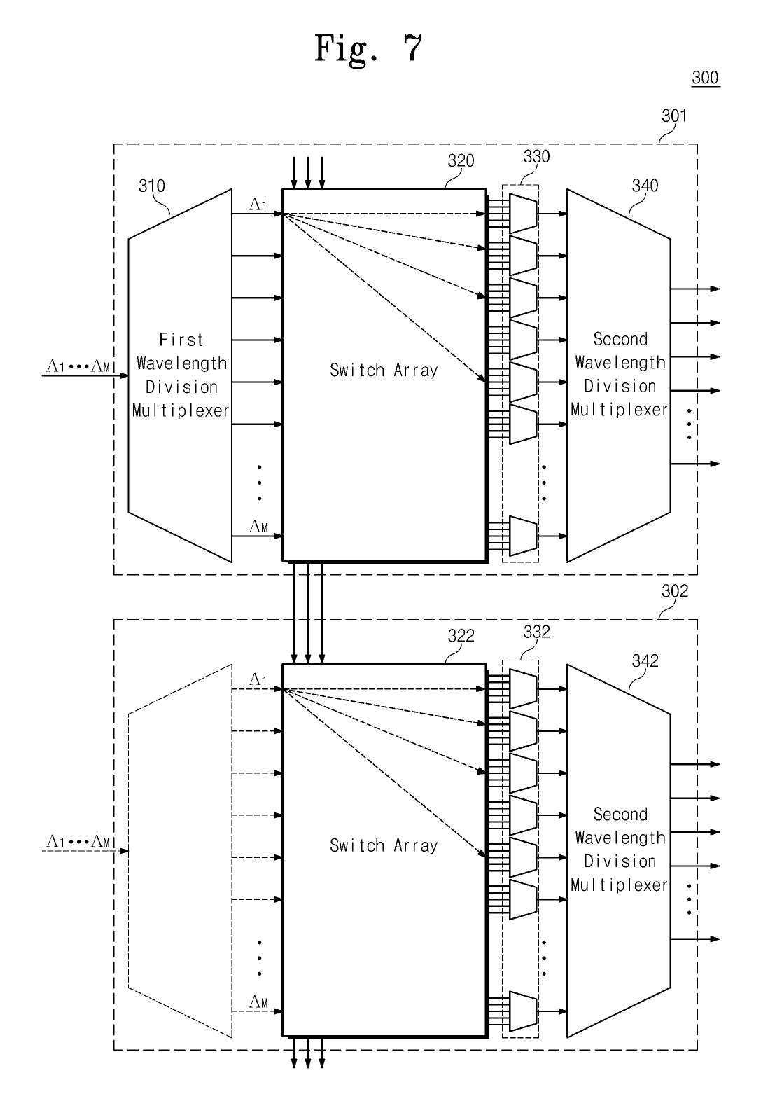

FIG. 7 is a view illustrating a method of increasing the number of input/output ports by coupling a plurality of wavelength selective switches 301 and 302 according to the present invention.

In a typical method for increasing the number of input/output ports of the wavelength selective switches, a cascade method in which one of the N number of output signals of the first wavelength selective switch 301 is connected to the input port of the second wavelength selective switch 302 is used. In this case, a total number of the output ports is (2N−1), that is, the sum of the (N−1) number of the output ports of the first wavelength selective switch 301, which is not connected to the second wavelength selective switch 302 and the N number of the output ports of the second wavelength selective switch 302. However, in this case, an insertion loss of the cascaded output ports is equal to the total sum of each of losses of the wavelength selective switches.

On the other hand, when the wavelength selective switch according to a preferable embodiment of the present invention is connected using the method described in FIG. 7, the loss increased due to the cascade method is a mere loss of a 1×2 unit optical switch. Thus, it is possible to increase the number of the output ports with only a small loss increase by connecting the plurality of wavelength selective switches 301 and 302.

Referring to FIG. 7, in order to connect the plurality of wavelength selective switches 301 and 302 to each other, one additional input port and one additional output port for connecting another wavelength selective switches are separately disposed at the front end of the 1×N optical switch.

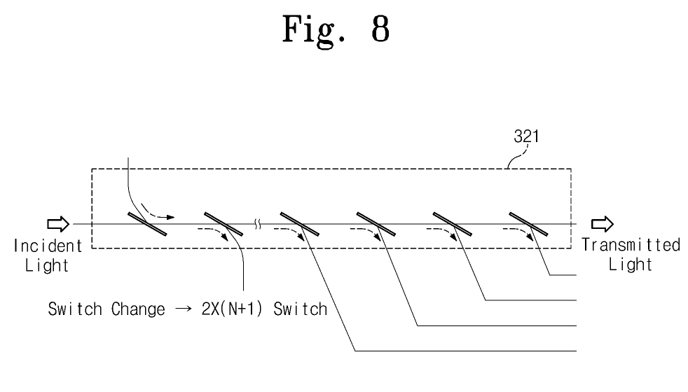

FIG. 8 is a view illustrating the method for changing a 1×N optical switch into a 2×(N+1) optical switch 321 separately adding one input port and one output port thereto so that a plurality of wavelength selective switches is connected to each other.

Referring to FIG. 8, the output port added to the 2×(N+1) optical switch 321 is correspondingly connected to the input port added to another wavelength selective switch according to channels. In case where the wavelength selective switches is connected to each other using the above-described method with the increased number of the 2×(N+1) optical switch 321, the optical signal inputted into a first wavelength division multiplexer 310 of the wavelength selective switch 301 may be outputted from a predetermined output port of the wavelength selective switch 301 as well as a predetermined output port of the second wavelength selective switch 302 by being inputted into the added input port of the second wavelength selective switch 302 through the added output port of the first wavelength selective switch 301.

When comparing an optical path of the optical signal outputted from the first wavelength selective switch 301 with an optical path of the optical signal outputted from the second wavelength selective switch 302, the optical signals passes through the same optical devices except that the optical path is changed by a 1×2 unit optical switch. Thus, although the plurality of wavelength selective switches are connected to each other using the above-described method, an additional loss increase does not occur.

As described above, in the typical wavelength selective switch, the plurality of wavelength division multiplexers are used. On the other hand, in the wavelength selective switch according to the present invention, only two wavelength division multiplexers, i.e., the first and second wavelength division multiplexers are used. Thus, the wavelength selective switch can be very simply constituted.

As described above, a wavelength selective switch fabrication method according to the present invention intactly uses an optical waveguide device fabrication method. For example, various planar waveguide optical device fabrication methods such as a polymer optical waveguide device fabrication method (Polymer Planar-Lightwave-Circuit-Type Variable Optical Attenuator Fabricated by Hot Embossing Process, Jin-Tae Kim, Choon-Gi Choi, and Hee-Kyung Sung, ETRI Journal, vol. 27, no. 1, February 2005, pp. 122-125.), a silica optical waveguide device fabrication method (An Etch-Stop Technique Using Cr203 Thin Film and Its Application to Silica PLC Platform Fabrication, Jang-Uk Shin, Dug-june Kim, Sang-Ho Park, Young-Tak Han, Hee-Kyung Sung, Jeha Kim, and Soo-jin Park, ETRI journal, vol. 24, no. 5, October 2002, pp. 394-400.), a semiconductor optical waveguide device fabrication method (Widely Tunable Grating Cavity Lasers, Oh-Kee Kwon, Eundeok Sim, Kang-Ho Kim, Jong-Hoi Kim, Ho-Gyong Yun, O-Kyun Kwon, and Kwang-Ryong Oh, ETRI Journal, vol. 28, no. 5, October 2006, pp. 545-554.), a SiON optical waveguide device fabrication method, and a silicon optical waveguide device fabrication method may be used.

Also, in the wavelength selective switch according to the present invention, all the wavelength selective switches can be constituted by applying different planar waveguide fabrication methods to fabricate each of the devices and by connecting the devices using optical fibers.

As described above, the present invention provides the wavelength selective switch that can be simply constituted using the planar lightwave circuit technology with only two wavelength division multiplexers.

Accordingly, in case where the wavelength selective switch according to the present invention is used, the number of the wavelength division multiplexers can be significantly reduced compared to the previous planar waveguide wavelength selective switches. Therefore, an entire size of the wavelength selective switch can be reduced, and a wavelength selective switch having a low defect rate, a high productivity, and a low cost can be fabricated.

In addition, in case where the wavelength selective switch according to the present invention is used, it is possible to effectively increase the number of the input/output ports by connecting the plurality of wavelength selective switches to each other without causing significant additional loss.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wavelength selective switch, comprising:
a first wavelength division multiplexer receiving optical signals of an M (integer greater than 1) number of wavelength channels to divide the received optical signals according to each channel, thereby outputting the divided optical signals;
an M number of optical switches changing a path of on an optical signal outputted from the first wavelength division multiplexer into one of an N (an integer greater than 1 and equal to or less than the integer M) number of output ports;
an (M+N−1) number of optical combiners respectively connected to the N number of output ports of the optical switches, the (M+N−1) number of optical combiners couples the N number of inputted optical signals to one output port; and
a second wavelength division multiplexer having an (M+N−1) number of input ports and an M number of output ports, wherein the (M+N−1) number of output signals of the optical combiners are connected to the input ports, respectively, and the inputted signals are multiplexed to output the multiplexed signals from the N number of output ports.

2. The wavelength selective switch of claim 1, wherein a J-th (reference symbol J is an integer greater than 1 and less than the integer M) output port of an I-th th (reference symbol I is an integer greater than 1 and less than the integer N) optical switch of the optical switches is connected to one of an input ports of an (I+J-1)th optical combiner.

3. The wavelength selective switch of claim 1, wherein, between the first wavelength division multiplexer output ports and the optical switches, variable optical attenuators or optical amplifiers are connected for each channel, which adjusts the optical signals according to the channels.

4. The wavelength selective switch of claim 1, wherein the first and second wavelength division multiplexers are implemented as an array-waveguide wavelength division multiplexer.

5. The wavelength selective switch of claim 1, wherein the first and second wavelength division multiplexers are implemented as a reflection type diffraction grating wavelength division multiplexer.

6. The wavelength selective switch of claim 1, wherein each of the optical switches adds one input port and one output port, thereby providing more outputs than the N number by connecting a plurality of wavelength selective switches to each other using the added input port and output port.

7. The wavelength selective switch of claim 1, wherein the wavelength selective switch is implemented as a single integrated optical device on one planar substrate.

8. The wavelength selective switch of claim 1, wherein optical devices used in the wavelength selective switch are connected using optical fibers, respectively.

9. A wavelength selective switch, comprising:
a first wavelength division multiplexer receiving optical signals of an M (integer greater than 1) number of wavelength channels to divide the received optical signals according to each channel, thereby outputting the divided optical signals;
an M number of optical switches changing a path of on an optical signal outputted by an M number of wavelength channels from the first wavelength division multiplexer into one of an N (an integer greater than 1 and equal to and less than the integer M) number of output ports; and
a second wavelength division multiplexer connected to the optical switches and having an (N×(M-1)+(N−1)×(N−1)+1) number of input channels and an N number of output channels, wherein a wavelength spacing between the input channels is 1/N of a channel wavelength of the optical signal, and a wavelength spacing between the output channels is 1/(N−1) of the channel wavelength of the optical signal.

10. The wavelength selective switch of claim 9, wherein a J-th (reference symbol J is an integer greater than 1 and less than the integer M) output port of an I-th (reference symbol I is an integer greater than 1 and less than the integer N) optical switch of the optical switches is connected to an (N×(I-1)+(N−1)×(J-1)+1)th input port of the second wavelength division multiplexer.
